(19) United States
(12) Patent Application Publication
(10) Pub. No.: US 2015/0269414 A1
(43) Pub. Date: Sep. 24, 2015

(54) VIRTUAL AUTOGRAPH SYSTEM

(71) Applicant: TIMOTHY ONYENOBI, MANCHESTER (GB)

(72) Inventor: TIMOTHY ONYENOBI, MANCHESTER (GB)

(21) Appl. No.: 14/221,397

(22) Filed: Mar. 21, 2014

(51) Int. Cl. G06K 9/00; H04N 1/32

(52) U.S. Cl. CPC G06K 9/00154; G06K 9/00187; G06K 9/00986; G06K 9/00973; H04N 1/32144

(57) ABSTRACT

The present invention is directed to a system and method for requesting and signing an autograph through the use of a software application on any communication device. The system allows for the transfer of entitled data when such an autograph request is made from a data capture device by processing and moving the data to a contact's device where it is again processed and moved back to the data capture device provided that the data capture device has a single option of displaying such entitled data once it has been moved from the contact's device in accordance with pre-established criteria and choices available on the data capture device. This may be achieved via a data exchange service that communicates directly to a server verifies users through the software application environment and/or tools installed on a communication device for transfer, acceptance and display of such entitled data.

### BACKGROUND OF THE INVENTION

1. Field of the Invention

The present invention generally relates to the request process for an autograph in a software application/mobile app on any communication device. More specifically, the present disclosure relates to the transfer of autographs/signatures/inscriptions which by any means represent an autograph from one communication terminal to another communication terminal via a software application environment/mobile app environment when such a request arises and for distinction a singular display of such autographs is provided when accessed on the data capture device.

2. Description of the Related Art

With the advent of technology, internet and social media, the world has become a truly small place where information about basically anyone and anything can be found.

With the increase of celebrity figures in all works of life and the growing global population as well as the advent of internet technology social media and proliferation of hand held devices, the current autograph system that involves physical exchange is quickly becoming obsolete.

An autograph request can be made by anyone and directed at anybody they see as a celebrity or figure worth getting an autograph from. At the moment, a request for an autograph has to be made either by direct or indirect contact with the celebrity or autograph-giver. In essence, autographs are received through established contact routes with the autograph-giver or through agencies or companies that can assist with the autograph requests.

For instance, the direct contact with the autograph-giver could be at a show, a chance meeting of the celebrity or autograph sessions to name a few. The indirect route could be either through someone that can contact the autograph-giver, the agency managing such autograph-givers or through companies that can assist with these to also name a few. The autograph-giver then responds through their desired contact route and the originator of the request gets their autograph. For companies that specialise in autograph requests, they already have autographed memorabilia ready for sale and sometimes use a route known or unknown to the individual(s) making such a request to achieve the same result of getting them autographs.

Through an indirect contact, the process of getting an autograph can be tedious and at times disappointing when the autograph request is not met accordingly. The autographs themselves can also be refuted through the opinions of some parties that may or may not have reasonable knowledge of the autograph in question and this can reduce the value of such autographs or lead individuals to believe that autographs through an established contact means are more authentic than other valid means. For instance forgery of autographs is a possibility. Direct contact with the autograph-giver might resolve this as its authenticity cannot be refuted.

A proposed means for sending autograph requests and receiving an autograph is through the use of communication networks or the power of the internet. This method will ensure faster communication, direct contact with the autograph-giver and a more responsive and accurate autograph request process. The main issue with this is the ease of duplication of such autographs and the certification of when such an autograph was actually made.

In accordance with the foregoing, there is need of a solution that allows users to send autograph requests through a secure route that allows for direct contact with the autograph-giver and also receive a response from the autograph-giver which cannot be refuted; as well as secure against virtual sharing or multiplication of autograph material to the limits experienced by physical autographs.

### SUMMARY OF THE INVENTION

The present invention is a system and method for requesting and signing an autograph through the use of a software application on any communication device. The system allows for the transfer of entitled data from a ‘data capture device’ to be processed and moved to a ‘contact's device’ where it is again processed and moved back to the ‘data capture device’ with a singular option of displaying such processed data once it has been moved back from a ‘contact's device’ in accordance with pre-established criteria and choices available on the ‘data capture device’. This may be achieved via a data exchange service that verifies users through a software application and/or tools installed on their device for transfer and acceptance of such entitled data.

In one embodiment, a method for sending an autograph request and securely transferring and relaying such entitled images from one device to another over a communication network and within a software environment. The system is comprised of a data exchange service which includes a secure database server, a communication network and the communication device(s). The communication device has a filter which is the software application for requesting and sending autographs. The database server stores information relating to users and their corresponding autographs such as the date an autograph was signed, location from where it was signed, and the unique identifier amongst other information that corresponds to the user.

In other embodiments, the data exchange service helps verify the transfer request via communication with the secure database server and through any available communication network security provision/policy to enable secure transit of the files from one communication device to the other. The data exchange service is implemented on any communication device through the use of a software application especially mobile apps and it is for requesting, accepting, sending, retrieving and displaying of an Autograph in a secure form and digitisation of autographs in a single format for storage. The data exchange service is secured by making use of a non-copyable data storage system and the implementation of any security protocol that further enhances such a system. The software application on the user's device accesses the database server via the communication network and verifies the user's unique signing keys which grant the respective user, usage of the data exchange service for operating and communicating with other users.

In some embodiments, with their unique signing keys stored on the database server the user can request, process, send, retrieve, sign and display a reduced-value autograph image corresponding to such users to display the autographs on the user's communication device.

In some embodiments, each step in the system works in tandem ensuring that the Autograph image is being transferred from one step to the other without the previous steps retaining any copy or identifiable data of the Autograph image itself. The transfer of the digital Autographs can operate via any combination of file transfer principles/protocols which allows for the secure transfer of digital data such that there can only be one digital copy in existence at each step of the autograph's request, transfer, response, storage and display steps. The final display of the autograph can either be as a soft copy format or a hard copy format however, in whatever format it takes there can only be one type of display in existence at any point in time

In some embodiments, the contact device may not be within the software environment and cannot use the autograph system via the software application but when a data capture device sends an autograph request to the contact address, a notification is sent to this address and the contact receives a unique identifier link which enables the installation of the software application on the contact device and assignment of a unique identifier such that once the contact device has fulfilled all obligations for operation within the software environment, the autograph request will then be received on the contact device. The unique identifier can be replaced by a signing key and grant the user of such a contact device the ability to respond to the autograph request if the contact so desires.

In some embodiments, a method involves identifying contact records on a personal communication device of a user. Each of the contact records includes a contact address of an individual associated with the respective contact record which the system identifies as the contact's unique identifier. The contact records are communicated to the data exchange service via a communication network. The individuals associated with the respective contact record may not have previously registered with the service but the software is able to send them a notification should the user decide to send them an autograph request.

In some embodiments, the autograph data is signed by a contact hence embedding a signature on a user's entitled data along with a date, time and contact location when the signature was embedded into the entitled data.

### BRIEF DESCRIPTION OF DRAWINGS

The various embodiments of the invention are set forth in the following description, taken in conjunction with the accompanying drawings, in which like reference characters refer to like parts throughout, and in which:

FIG. 1 illustrates a flowchart depicting an overview of the Autograph feature on communication devices between two users.

FIG. 2 illustrates a flowchart depicting how two users can use the autograph feature within the software environment by fulfilling all obligations of using the software application which is in this case a mobile app.

FIG. 3 illustrates the diagrammatic overview of the autograph request system.

### DETAILED DESCRIPTION

The present invention discloses a system and method that allows for the transfer of entitled data when an autograph request is made from a data capture device by processing and moving the data to a contact's device where it is again processed and moved back to the data capture device provided that the data capture device has a single option of displaying such entitled data once it has been moved from the contact's device in accordance with pre-established criteria and choices available on the data capture device.

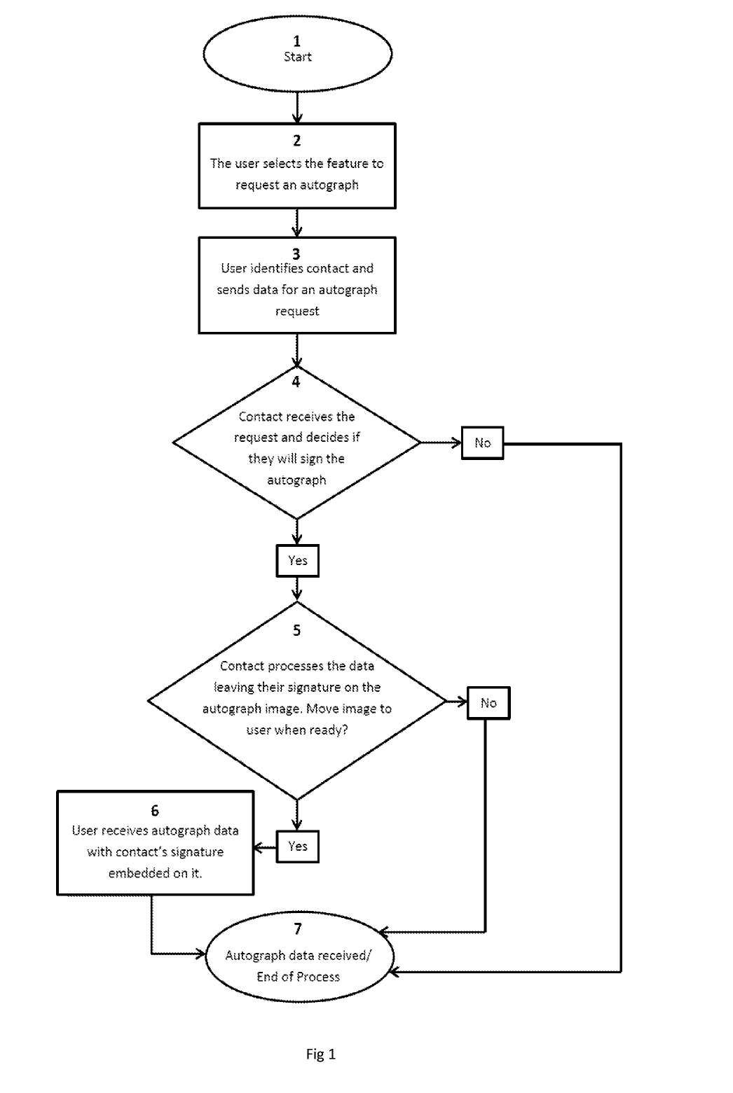

The method associated with the system for requesting autographs between users within a software application environment is done via a secure communication network interacting with a secure server. FIG. 1 shows the user of the data capture device having the software application installed on their communication device which in this case, the device belongs to User A. At 1 User A starts the autograph request process and in step 2 selects the feature to install the software application from the software application environment. In step 3, the user identifies a contact from their contact record and sends them an autograph request. The contact receives the contact request in 4 and decides then if they want to sign the autograph. If they decide to send the autograph, the process goes to 5 where the contact processes the data and decides to move the autograph back to the user. If the contact does not wish to sign the autograph or process the data, the process ends in 7. When the user receives the signed autograph in 6, the process will be complete by ending in 7.

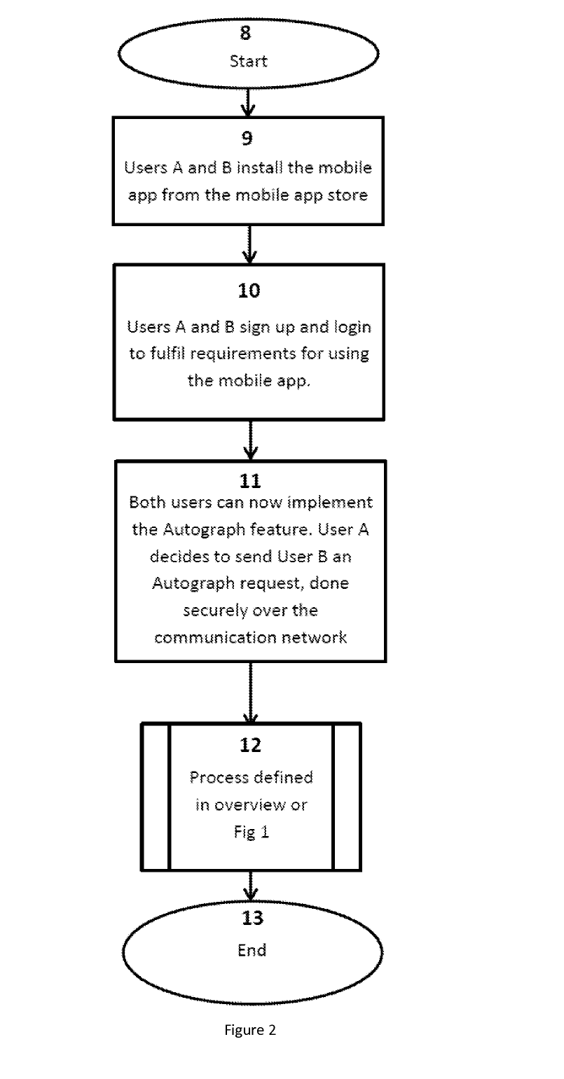

In FIG. 2 user A sends an Autograph request from their data capture device to the contact device for user B within the same software application environment. This system and method covers software application on computer or handheld devices however, for illustration purposes, our software application in this description is a mobile app. At 8, user A and user B decide they need to implement the autograph request via the mobile app. At 9 both users install the app on their communication devices. Both user's signup and login at 10 to fulfil obligations for using this app and their login details/unique signing keys are stored on the app's database server hence fulfilling the requirements for using the app. At 11, both users are ready to use the autograph request feature on the app. Here, user A decides to send user B an Autograph request. This request is sent over a network which is followed by either an entitled autograph response or no response from intended user B according to FIG. 1. A response depends on whether the intended user B has not seen the request, plans to respond later or does not wish to respond at all. The process ends in 13 where the autograph process, as illustrated in FIG. 1 ends.

In another embodiment, user A has sent an autograph request from their data capture device to the contact device of user C, who, unlike user A, has not installed the software application on their communication device/contact device. The data for the autograph request is then stored on the server and/or a notification is sent back to user A informing them that user C is not within the same software application environment. User C also receives a similar notification containing a unique link where the user can install the software. Once the software is installed the server automatically recognises that user C has installed the software via the unique identifier which the initial request had. The autograph request can then be processed since user C is now within the software environment.

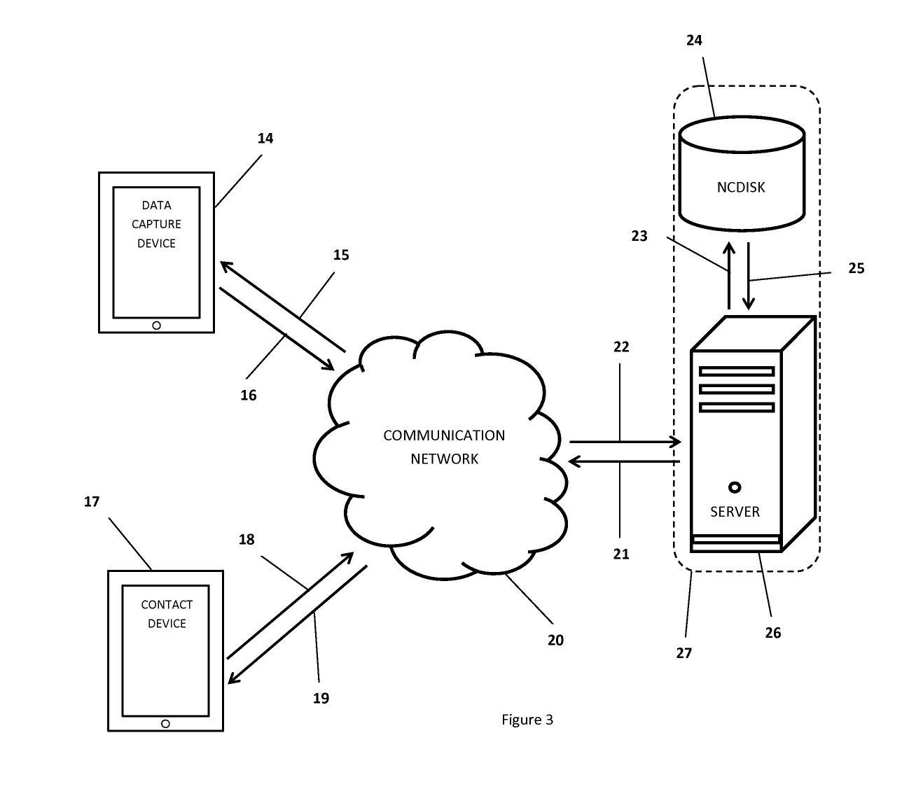

In FIG. 3, a data capture device 14, is a communication device which belongs to a user that sends an autograph request 16, to a contact device 17, through the communication network 20. This is done through the software environment that acts as a filter with the network security protocols and non-copyable data storage system implemented throughout the autograph request. The communication network 20 receives the autograph request and it interfaces 22, 21, with the database server 27. It also detects if the contact device has been registered to the database and sends the contact device the autograph request 19 via a communication network 20. The contact device receives the request and processes it but is not obligated to send a response 18. A response 18, to the autograph request is done when the contact device installs and fulfils requirements for using the software application. The response 18 can either be a signed autograph or a declined autograph request. The communication network 20 receives the response and interfaces with the database server 27. The database server 27 acknowledges the signed autograph and through the implementation of a non-copyable disk system the autograph cannot be duplicated but sends a notification 21 via a communication network 20 and the response 15 is received on the data capture device. An additional security layer is implemented through another non-copyable data storage system on the database server which is executed by having a back-end server 26 that receives requests 22, 25 and sends responses 21, 23, to a non-copyable disk 24 which is the database. Data is transferred between the server and database through the use of secure file transfer protocols offered by 23 and 25.

1. A system for requesting and signing an autograph through the use of a software application on communication devices, the system comprising:
an autograph request sent via the software application;
an autograph request signed via the software application;
an autograph displayed via the software application.

2. The system as recited in claim 1 comprising:
a database server having a list of users, the database server also storing user information, their contact information and data necessary for using a software application;
a data exchange service connected to the database server for the transfer of data through the use of a communication network which interacts with the user's communication device;
a software application being implemented on the user's communication device for interacting and securing interactions with the data exchange service.

3. The system as recited in claim 1 comprising:
an autograph request including entitled data;
a user's communication device where one device is the data capture device;
a user's communication device where another device is the contact device;
a data capture device where the autograph request originates from;
a contact device where the autograph request is being sent;
the data capture device has fulfilled all obligations for using the software application.

4. The system as recited in claim 1 comprising:
an autograph request including entitled data;
a non-copyable data storage system that prevents duplication of the entitled data;
a software application that implements a non-copyable data storage system;
a database server that implements a non-copyable data storage system;
a data exchange service that implements a non-copyable data storage system.

5. The system as recited in claim 1 comprising:
an autograph request including entitled data;
network security protocols to secure data in transit;
a data exchange service that implements the network security protocols;
a software application that implements the network security protocols;
a database server that implements the network security protocols.

6. The system as recited in claim 1 comprising:
an autograph request including entitled data;
the autograph data can be processed and moved by the user from the user's communication device.

7. The system as recited in claim 1 comprising:
a database server containing unique signing keys for creating digital identifiers that corresponds to the user of the software application;
the database server contains unique identifiers that corresponds to the contact records of an individual not using the software application;

8. The system as recited in claim 1 comprising:
a database server containing unique signing keys for creating digital identifiers that corresponds to the user of the software application;
the unique identifier is replaced with signing keys once an individual decides to become a user of the software application.

9. The system as recited in claim 1 comprising:
an autograph request including entitled data;
the autograph data is received on the data capture device;
the autograph data is embedded with a contact's signature.

10. The system as recited in claim 1 comprising:
an autograph request including entitled data;
the autograph data is stamped with the date, time and location that a contact embedded their signature.

11. The system as recited in claim 1 comprising:
an autograph request including entitled data;
the software application displays the autograph via a singular mode;
the mode of display is on the user's communication device.

12. The system as recited in claim 1 comprising:
an autograph request including entitled data;
the software application displays the autograph via a singular mode;
the mode of display is through a print-out system and method.
